(19) United States
(12) Patent Application Publication
(10) Pub. No.: US 2012/0227901 A1
(43) Pub. Date: Sep. 13, 2012

(54) METHOD OF LAMINATION USING RADIO FREQUENCY HEATING AND PRESSURE

(75) Inventors: Morgana Lynn Fall, Albany, NY (US); Shawn Michael Allan, Troy, NY (US); Holly Sue Shulman, Schenectady, NY (US)

(73) Assignee: CERALINK, INC., Troy, NY (US)

(21) Appl. No.: 11/751,518

(22) Filed: May 21, 2007

Related U.S. Application Data
(60) Provisional application No. 60/803,632, filed on Jun. 1, 2006.

(51) Int. Cl. B29C 65/14

(52) U.S. Cl. 156/274.8

(57) ABSTRACT

A method for producing laminated materials is taught, wherein materials are bonded by heating using radio frequency (RF) energy while simultaneously applying pressure. The process for laminating a single piece is generally completed in a matter of seconds, as opposed to the hour(s) required to produce a glass laminate using the current state-of-the-art technology.

### CROSS-REFERENCE TO RELATED APPLICATIONS

This application claims the benefit of Provisional Application No. 60/803,632, filed in the US Patent and Trademark Office on 1 Jun. 2006.

### FEDERALLY SPONSORED RESEARCH AND DEVELOPMENT

Part of the commercialization effort for this invention is made under a grant from the U.S. Department of Energy, Industrial Technologies Program with support from the Inventions and Innovations Program, Contract No. DE-PS36-06GO96001. No part of the invention itself was made under the above-referenced grant or other federally sponsored research and development.

### PARTIES TO JOINT RESEARCH AGREEMENT

PPG Industries has provided research and commercialization support, although they do not participate in the invention.

Thermex Thermatron has provided insight into equipment manufacture for the process, although they do not participate in the invention.

### BACKGROUND OF THE INVENTION

1. Field of the Invention

This invention lies in the field of lamination heating materials and methods, specifically in the use of RF heating methods for laminates.

2. Description of Related Art

Currently, the standard commercial lamination process requires heat sources such as electric heating or heat lamps and a plurality of heating ovens. Two layers of structural material to be laminated are inserted into an oven with an interlayer, such as vinyls, glues, plastics, resins, polymer adhesives, inorganic polymer adhesives, and filled polymers, placed between the two layers. The oven is heated, heating the materials being laminated and melting the interlayer, and rollers within the oven press the materials together to form a tight, secure bond. The heating-and-pressing process may occur more than once and may occur at different temperatures, depending on the material being laminated.

Cooling may occur, either intentionally or unintentionally, between heating cycles.

Once the material has been heated and rolled, it is autoclaved and perhaps rolled for a period of time based on the material being laminated. Cooling may occur, intentionally or unintentionally, before the material is placed in the autoclave.

When the material is removed from the autoclave, it is cooled and is then ready for use.

RF heating technology is used in the wood, paper, and plastic packaging industries, and provides significant time and energy savings in those industries.

The need is felt outside of the wood, paper, and plastic packaging industries for a lamination process that provides significant savings of energy and time over the current art.

### BRIEF DESCRIPTION OF THE DRAWINGS

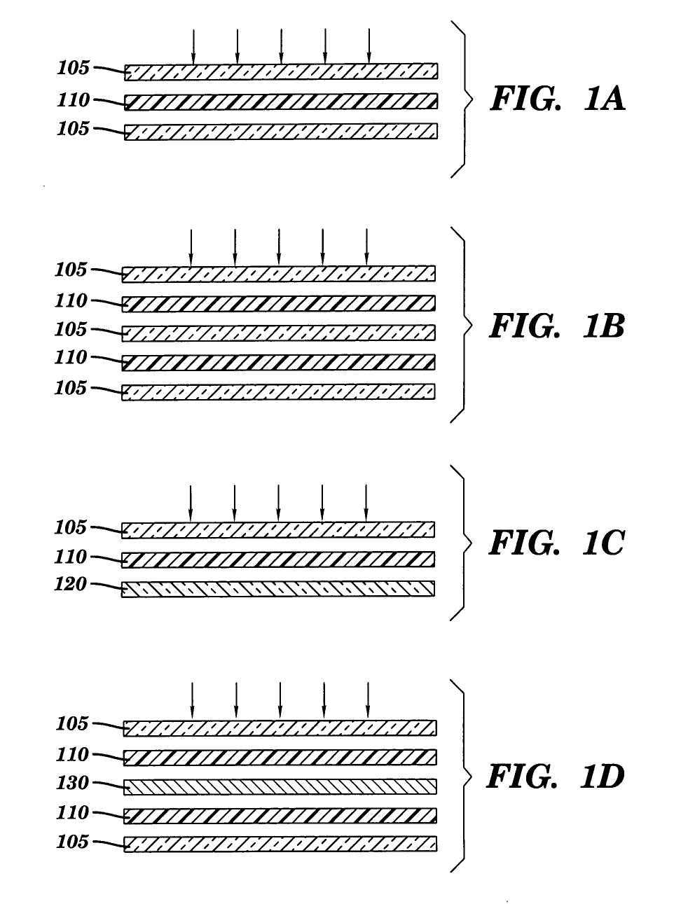

Referring now to FIG. 1, an overall diagrammatic view of RF lamination of structural material layers is shown.

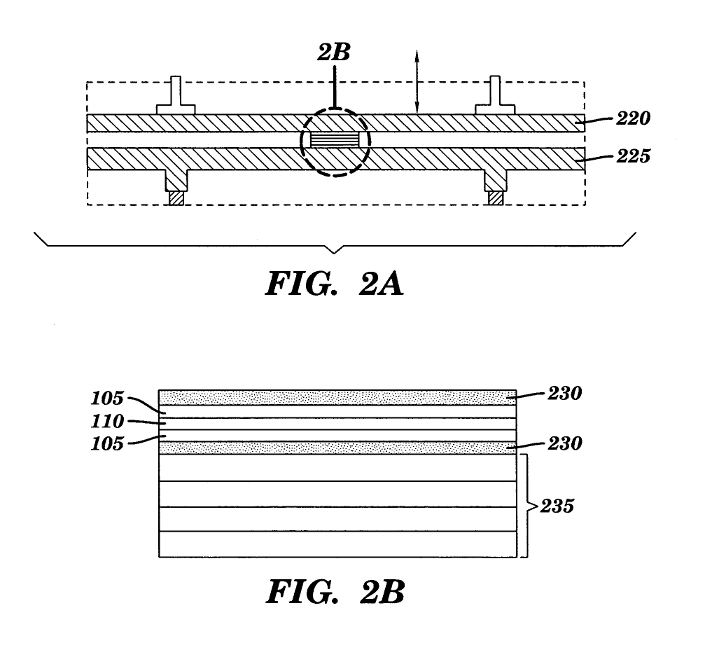

Referring now to FIG. 2, an experimental setup for vinyl heating in an RF applicator is shown.

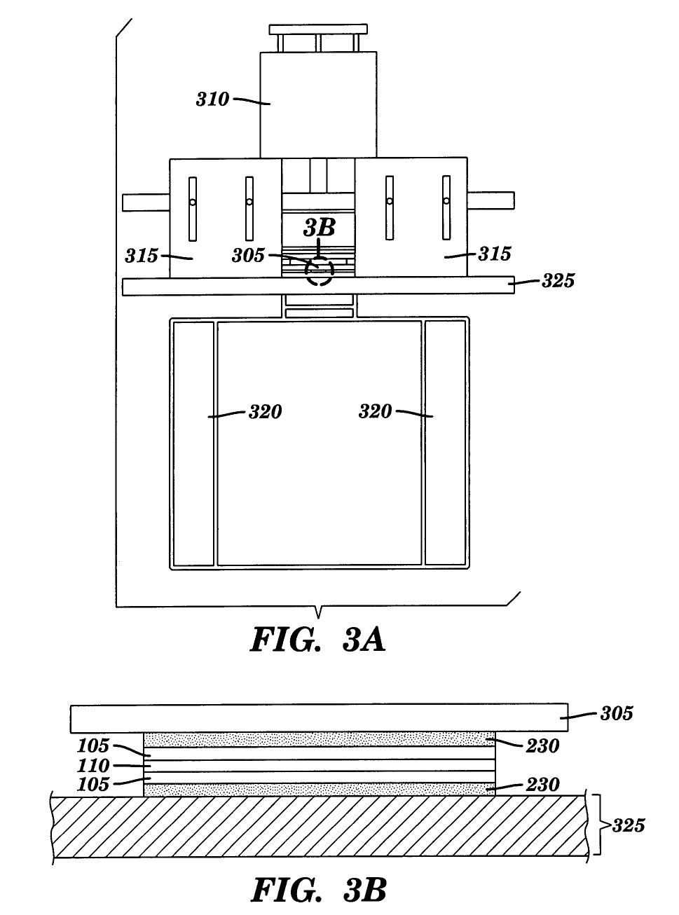

Referring now to FIG. 3, a press used for vinyl lamination is shown.

### DETAILED DESCRIPTION OF THE INVENTION

Referring now to FIG. 1, an overall diagrammatic view of RF lamination of structural material layers is shown. A vinyl interlayer or other polymer interlayer is placed between two or more layers of structural layer material such as glass producing a layered material, and the layered prelaminate material is then placed in an RF press. By applying RF heat and pressure to the layered prelaminate material, a laminate is produced.

In another embodiment a structural layer material other than glass, or a composite of materials may be used in this method. Such materials include, but are not limited to, glass, flat glass, curved glass, coated glass, tinted glass, fused silica (quartz) glass, soda lime glass, borosilicate glass, lead silicate glass, aluminosilicates glass, non-silica based oxide glass, halide glass, chalcogenide glasses, tempered glass, ion-exchange strengthened glass, polymethylmethacrylate (PMMA), polycarbonate (PC), polyethylene terephthalate (PET), polypropylene (PP), polyethylene (PE), polyvinylidene fluoride (PVDF), polytetrafluoroethylene (PTFE), polyimides, polyamides, all oxide, carbide, nitride, and boride ceramics and glasses, including but not limited to aluminum oxide (Al₂O₃, alumina, sapphire), spinel (MgAl₂O₄), silicon aluminum oxynitride (SiAlON), silicon nitride (Si₃N₄), and aluminum nitride (AlN), magnesium oxide (MgO), magnesium fluoride (MgF₂), boron nitride (BN), boron carbide (B₄C), titanium diboride (TiB₂), and aluminum oxynitride (AlON), titanium carbide (TiC), silicon carbide (SiC), tungsten carbide (WC), hafnium carbide (HfC), zirconium carbide (ZrC).

Structural-and-interlayer layers as shown in FIG. 1 are loaded into an RF press. RF then heats the interlayer to the point of melting and flow. See Table 1. RF energy is generally specified as the range of electromagnetic frequencies from substantially 0.1 to 500 MHz. In the current invention, the preferred frequency range for processing laminates is substantially from 10 to 40 MHz, more specifically 27.12 MHz. 27.12 MHz, along with 6.78, 13.56, and 40.68 MHz, are allowed for industrial, scientific, and medical use, and are commonly referred to as the ISM frequencies, as currently designated by the International Telecommunication Union, Radiocommunication Sector, ITU-R 5.138, 5.150, and 5.280, and as currently designated in the United States by Part 18 and Part 15 Subpart B of the FCC Rules.

In one embodiment, the structural layer materials do not heat because a large portion of the RF energy passes through the structural glass, ceramic, and/or plastic layers. The dielectric properties (permittivity and loss) of the structural glass, ceramics, and/or plastic layers being laminated cause them to be relatively transparent to the RF energy. The dielectric properties of the interlayer cause the interlayer to absorb RF energy, producing heat, more so than the structural glass, ceramic, and/or polymer structural layers. Therefore in the laminate, the interlayer will preferentially heat.

In another embodiment, one or more of the structural layers heat in the RF field more than does the interlayer.

The assembled layers shown in FIG. 1 may be pressed together until the laminate is substantially bonded. In a preferred embodiment, this bonding requires substantially 1 second to 30 minutes. A preferred embodiment requires substantially 0-300 psi to create a substantially bonded laminate.

Note that the energy required for the RF process for glass lamination is significantly less than the energy required for the traditional autoclave process for glass lamination.

The resulting product may be optically transparent, translucent or opaque.

Referring now to FIG. 2, an experimental setup for interlayer heating in an RF applicator is shown. The setup comprises an RF applicator or an RF press. The RF applicator or RF press comprises two electrodes inside a shielded chamber that operate at substantially 0.1-100 MHz, between 20-40 MHz in a preferred embodiment, or specifically 27.12 MHz. 27.12 MHz is designated for Industrial, Scientific, and Medical (ISM) use by international treaties. Other ISM allowed frequencies specifically covered by this patent are 6.78 MHz, 13.56 MHz, and 40.68 MHz.

One electrode may be movable, while the other electrode may be fixed, or both electrodes may be fixed, or both electrodes may be moveable.

In a preferred embodiment for the RF press, the top electrode is movable while the bottom electrode is fixed. Space between the two electrodes changes the RF field intensity; the intensity is increased by moving the electrodes closer together, decreased by moving the electrodes further apart.

In a preferred embodiment, the RF press is designed to deliver pressure to the structural and interlayer materials as the RF field is delivered. In one embodiment, only the top electrode is movable; in a second embodiment, the bottom electrode is movable; in a third embodiment, both electrodes are movable.

In an alternate embodiment, the RF applicator is not designed to deliver pressure, though some pressure may be exerted by lowering an upper electrode onto a flat piece of buffer material such as polypropylene, polyethylene, mylar, fish paper, or other insulating material resting on top of the material being processed. The buffer provides thermal insulation and protection against surface abrasions and scratches on the product. The RF applicator may be designed to deliver pressure and remain within the scope of the invention. Referring now to FIG. 3, a press used for RF lamination is shown. An RF press is designed to deliver an RF field along with pressure on the material being processed. Similar to the RF applicator described in FIG. 4, the RF press contains two electrodes, either or both of which may be movable, although in a preferred embodiment a top electrode is movable and a bottom electrode is fixed. The movable electrode may, in a preferred embodiment, be moved with a hydraulic, pneumatic, or manual lever system. A hydraulic system is generally required to provide adequate pressure of substantially 0 to 350 psi on the product. The hydraulic mechanism may be moved automatically, or manually by a lever external to the RF field. The upper electrode in this preferred embodiment provides pressure against the material being processed. In a preferred embodiment, the two electrodes are not confined in a chamber; shielding is applied around the outside of the electrode to prevent RF leakage.

The pressure exerted on the material being laminated is, in a preferred embodiment, adjustable using the RF press. In other embodiments, the pressure may be constant. The pressure may be raised prior to raising the temperature with RF energy, after temperature is raised, or simulataneously as temperature is raised.

Clear and tinted autoglass, window glass, borosilicate glass, transparent ceramics, acrylic, and polycarbonate—do not increase substantially in temperature on experimental exposure to a field of RF energy at substantially 27.12 MHz. For a moderate-to-good RF heating material, a temperature increase of 50-200° C. is expected; the lack of heating indicates that the glass is relatively non-absorptive of RF energy at substantially 27.12 MHz. See Table 1.

TABLE 1
RF testing glass susceptibility

| Clear Autoglass | | Green Tint Autoglass | | Dark Gray Autoglass | |
|---|---|---|---|---|---|
| Time (sec) | ° C. | Time (sec) | ° C. | Time (sec) | ° C. |
| — | 25 | 30 | 32 | 30 | 32 |
| 60 | 32 | 60 | 33 | 60 | 32 |
| 120 | 34 | 120 | 36 | 120 | 34 |

In other embodiments of the invention, other types of glass, ceramics, and polymers may comprise the structural laminate layers. Structural polymer materials that may be used include but are not limited to polymethylmethacrylate (acrylic) and polycarbonate. Polycarbonate is currently used in safety and security glass, and on the inside of an armored vehicle window to shield the occupant(s) of that vehicle from glass fragments that would be created by the impact of a projectile such as a bullet.

Yet other embodiments of the invention may use transparent and/or opaque ceramics to create layers. Some visibly opaque ceramics are transparent to infrared light and are used in applications such as aerospace optics. Ceramics that may be used include but are not limited to aluminum oxide (Al₂O₃, alumina, sapphire), spinel (MgAl₂O₄), silicon aluminum oxynitride (SiAlON), silicon nitride (Si₃N₄), aluminum nitride (AlN), aluminum oxynitride (AlON), boron nitride (BN), boron carbide (B₄C), titanium diboride (TiB₂), magnesium oxide (MgO), and magnesium fluoride (MgF₂).

In another embodiment, a sacrificial interlayer is used to provide heat for applying a coating to a glass, ceramic, or polymer substrate. The interlayer may be adhesive or non-adhesive. The interlayer may be removed mechanically or chemically after processing, or left in place. Coatings are generally too thin to preferentially heat in RF to the point of curing. The absorbing interlayer placed between two plates of transparent substrate, provides the preferential heat required for applying the coating.

Experimental parameters and results for laminating using an RF press are shown in Table 2, below. Pressure and RF power were adjusted to produce laminates in 7 to 99 seconds, reaching outer glass temperatures of only 35 to 115° C., using pressures from 40 to 240 psi.

TABLE 1
Experimental parameters for laminating using an RF press.

| | Structural | | Pressure | Temp | Time | |
|---|---|---|---|---|---|---|
| Run | Layer | Interlayer | PSI | •C. | sec | Result |
| 1 | Clear | PVB-3 | 53 | 104 | 30 | Clear |
| | autoglass | | | | | |
| 2 | Clear | PVB-2 | 53 | 105 | 30 | Clear |
| | autoglass | | | | | |
| 3 | Gray tint | PVB-1 | 177 | 115 | 15 | Clear |
| | autoglass | | | | | |
| 4 | Green tint | PVB-2 | 177 | 100 | 30 | Clear |
| | autoglass | | | | | |
| 5 | Gray tint | PVB-2 | 106 | 116 | 30 | Clear |
| | autoglass | | | | | |
| 6 | Green tint | PVB-1 | 177 | 108 | 30 | Clear |
| | autoglass | | | | | |
| 7 | Polycarbonate | TPU | 177 | 76 | 99 | Clear, few |
| | | | | | | air bubbles |
| 8 | Acrylic | TPU | 177 | 70 | 70 | Clear, few |
| | | | | | | air bubbles |

As an example, glass laminates created in the RF press may be pressed to clarity in substantially 7-20 seconds. The process of constructing them uses very little power. The glass surface is heated to a maximum of substantially 35-45° C. using three different PVB interlayers when pressing in under substantially 20 seconds. For longer press times, the glass or plastic surface temperature achieves substantially 75 to 115° C. The PVB interlayer exceeded 140° C. in all cases, which is substantially the temperature required to form the laminate bond.

As another example, laminates containing structural polymers in the RF press are pressed to clarity in 30 to 180 seconds. The process of constructing them uses very little power. The polymer surface is heated to substantially 76 to 115° C. using TPU interlayers.

The RF press also yields better clarity results than does RF alone, with most of the laminates being characterized as mostly clear.

Other materials that do not participate in the bonding of the layers, can be inserted within the interlayer, including but not limited to cloth, silk, paper, polymers, solar cells, circuits, ceramics, and light emitting diodes (LEDs). These can be used for decorative or technical applications. In one example, a sheer piece of silk is placed between two sheets of interlayer film, which is then placed between two sheets of glass. In another example, a cellulose acetate film printed with images and words is included in the laminate between two sheets of interlayer film placed between two sheets of glass.

The interlayer film can be smaller, or larger than the structural layers being bonded. This can be used for design purposes.

An EVA or TPU interlayer, for example, may be used to bond a structural glass plate to a sheet of polycarbonate.

Experimentally, 4″×4″ sections of glass laminate can be processed to substantial optical clarity in 7 to 20 seconds. Experimental energy consumption is 6.6 BTU/ft².

These results clearly demonstrate that an RF press is a useful and viable method for laminating an interlayer between clear laminates that retains the clarity of the structural material. This, coupled with the energy savings realized by using RF pressing makes this invention useful in industries that laminate glass and other composites.

In another embodiment, RF energy and/or pressure may be applied in pulses to the material being laminated.

It is conceivable and within the scope of the invention that other types of glass can be laminated utilizing the RF methods described herein.

It is also conceivable and within the scope of the invention that individual layers of the finished laminated material may be made of the same material as other layers or layers may be made of different materials; for example, polycarbonate and tempered glass may be laminated using the RF methodology described herein, or any other combination of layers may be made within the scope of the invention.

It is also conceivable and within the scope of the invention that composite materials other than glass can be laminated utilizing the RF methods described herein. Such materials may include any materials that are laminated together, specifically excluding wood, plastic packaging, and paper.

It is also conceivable and within the scope of the invention that multiple layers of composite materials, of similar or different compositions, can be laminated together in RF using interlayers that may be the same material between all layers or may differ between layers. For example, a laminate containing the layering of borosilicate, vinyl, tempered glass, glue, soda lime glass, resin, transparent ceramic is within the scope of the invention, as is a laminate containing the layering of glass, vinyl, glass, vinyl, glass.

It is also conceivable and within the scope of the invention that other interlayer materials can be used to create a bond between the materials being laminated. Examples of other interlayer materials may include, but are not limited to, polyvinylbutyral (PVB), ethylene vinyl acetate (EVA), polyethylene vinyl acetates (PEVA), thermoplastic polyurethane (TPU), polyvinylchloride (PVC), glues, plastics, resins, polymer adhesives, inorganic polymer adhesives, polyurethanes, aliphatic polymers, vinyls, epoxies, and filled polymers that can be pressed substantially free of defects, and may be pressed to clarity where intended, while maintaining a bond between the structural material layers.

It is also conceivable and within the scope of the invention that the materials used need not be optically clear. Materials that are opaque or translucent to visible light and transparent or translucent to other wavelengths of light are also of use in industrial, scientific and medical applications and their use is within the scope of the present invention.

In one embodiment, an advantage of the invention is that RF energy is shown to preferentially heat the interlayer over the structural glass material being laminated, at a savings of up to 95% (ninety-five percent) over the traditional autoclave process.

The embodiments provided here are examples only and are not intended to be a complete listing of possible embodiments, nor should they be construed as an exclusive listing of embodiments. Variations in the described invention and its uses are possible within the scope of this disclosure without departing from the subject matter coming within the scope of the claims herein, and a reasonable equivalency thereof, which I regard as my invention.

1.-30. (canceled)

31. A method of forming a bonded laminate, the method comprising the steps of:
placing an interlayer bonding material between two layers of structural material to form a prelaminate, the interlayer bonding material consisting of polyvinyl butyral;
placing the prelaminate into an RF press between a movable RF electrode and a stationary RF electrode;
utilizing RF energy emanating from the movable and stationary RF electrodes to heat the interlayer bonding material to its softening point;
pressing the prelaminate by pressing down on the prelaminate with the movable RF electrode such that substantially all of any gas bubbles located between the two layers of structural material are removed; and
cooling the interlayer bonding material.

32. The method of claim 31, wherein the RF press comprises an RF shield.

33. (canceled)

34. The method of claim 31, wherein the prelaminate further comprises an additional material between the two layers of structural material, the additional material not contributing to laminate bonding.

35. The method of claim 34, wherein the additional material comprises at least one of cloth, silk, paper, polymer, solar cells, circuits, ceramics, and light emitting diodes.

36. The method of claim 31, wherein the heating of the interlayer bonding material is used to cure a coating on an adjoining surface of at least one of the two layers of structural material, and wherein the interlayer bonding material may be chemically or mechanically removed from the at least one of the two layers of structural material.

37. The method of claim 31, wherein the bonded laminate is transparent to visible light.

38. The method of claim 31, wherein the bonded laminate is translucent to visible light.

39. The method of claim 31, wherein the bonded laminate is opaque to visible light.

40. The method of claim 31, wherein the method comprises a pulsing application of at least one of RF energy and pressure.

41. (canceled)

42. (canceled)

43. The method of claim 31, wherein the interlayer bonding material consists of thermoplastic polyurethane.

44. The method of claim 31, wherein the interlayer bonding material consists of ethylene vinyl acetate.

45. The method of claim 31, wherein at least one of the two layers of structural material comprises a glass.

46. The method of claim 31, wherein at least one of the two layer of structural material comprises a ceramic.

47. The method of claim 31, wherein at least one of the two layers of structural material comprises a polymer.

48. The method of claim 31, wherein the two layers of structural material have substantially the same composition.

49. The method of claim 31, wherein the two layers of structural material have substantially different compositions from each other.

50. The method of claim 31, wherein the two layers of structural material are not substantially heated during the step of utilizing RF energy to heat the interlayer bonding material to its softening point.
